(19) United States
(12) Patent Application Publication
(10) Pub. No.: US 2012/0272204 A1
(43) Pub. Date: Oct. 25, 2012

(54) UNINTERRUPTIBLE UPGRADE FOR A BUILD SERVICE ENGINE

(75) Inventors: Daniel Olewski, Redmond, WA (US); Kenneth Jordan, Redmond, WA (US)

(73) Assignee: Microsoft Corporation, Redmond, WA (US)

(21) Appl. No.: 13/091,168

(22) Filed: Apr. 21, 2011

(51) Int. Cl. G06F 9/44

(52) U.S. Cl. 717/100

(57) ABSTRACT

An upgrade technique for a build service engine enables continuous execution of build execution tasks without interruption to an in-progress build job. A build service engine may include a software build service coupled to one or more build machines. The build machine may include a build agent procedure that activates a helper process to execute a build script containing one or more build execution tasks. The build agent procedure and the helper process utilize a local data store to store information pertaining to the status of in-progress build scripts in a manner that allows the build agent procedure to be upgraded without interrupting the in-progress build scripts.

### BACKGROUND

Software development teams typically utilize a software build service to package a software application in a form suitable for delivery, installation, and/or execution for an intended user. A software application may have thousands of source files that may need to be compiled, linked, tested, and/or packaged with other components such as executable files, dynamic link library files, registry configurations, binary files, and so on. The software build service can take several hours to perform all the tasks needed to generate the software application. As such, the software build service is a time and resource intensive process. Any interruptions to the software build service would result in the consumption of additional time and resources which may not be practical or feasible.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An upgrade technique for a build service engine enables continuous execution of build execution tasks without interruption. A build service engine may utilize several build machines to generate a software application in accordance with directives contained in a build definition file. The build definition file may contain build execution tasks used to produce the software application. The build execution tasks may be distributed to several of the build machines and processed concurrently subject to dependencies between the various build execution tasks.

A build machine may include a build agent procedure that controls the execution of build execution tasks on a particular build machine. The build agent procedure may receive a build request to perform one or more build execution tasks. In response to the build request, the build agent procedure activates a helper process to execute a build script that performs the requested build execution tasks. The build agent procedure and the helper process utilize a local data store to store information pertaining to the execution of the build script in a manner that allows the build agent procedure to be upgraded without interruption to the execution of the build script.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrates an exemplary system for an uninterruptible upgrade for a build service engine.

FIG. 2 illustrates an operating environment.

FIG. 3 illustrates an exemplary local data store.

FIG. 4 is a flow chart illustrating an exemplary first process for an uninterruptible upgrade for a build service engine.

FIG. 5 is a flow chart illustrating a second process for an uninterruptible upgrade for a build service engine.

FIG. 6 is a flow chart illustrating a third process for an uninterruptible upgrade for a build service engine.

FIG. 7 is a block diagram illustrating an exemplary communications framework.

FIG. 8 is a block diagram illustrating an exemplary build machine.

FIG. 9 is a block diagram illustrating an exemplary software build service.

### DETAILED DESCRIPTION

Various embodiments are directed to a mechanism for an uninterruptible upgrade for a build service engine. Generally, members of a software production team may use software development clients to access software build services provided by a build service engine to produce a software application. The build service engine creates a virtual software build platform to accommodate the requirements of a build job as set forth in a build definition file. The build service engine assigns the needed resources to accomplish the build execution tasks that build a software application in a timely manner.

A build service engine may have multiple build machines where each build machine is assigned one or more build execution tasks to perform in order to generate a portion of a software application. A build machine is communicatively coupled to a software build service which assigns build execution tasks to the build machine. The build execution tasks are formulated in a build script. The build machine contains a build agent procedure which initiates the execution of a build script through a helper process. The helper process initiates and monitors execution of the build script. The helper process executes independent of the build agent procedure so that the build agent procedure may be updated without interrupting the execution of a build script. The build agent procedure and the helper process are independent processes that utilize a common data store to store configuration and execution status data pertaining to the build scripts. In this manner, the build agent procedure can be upgraded and serviced more frequently with minimal impact to in-progress build jobs.

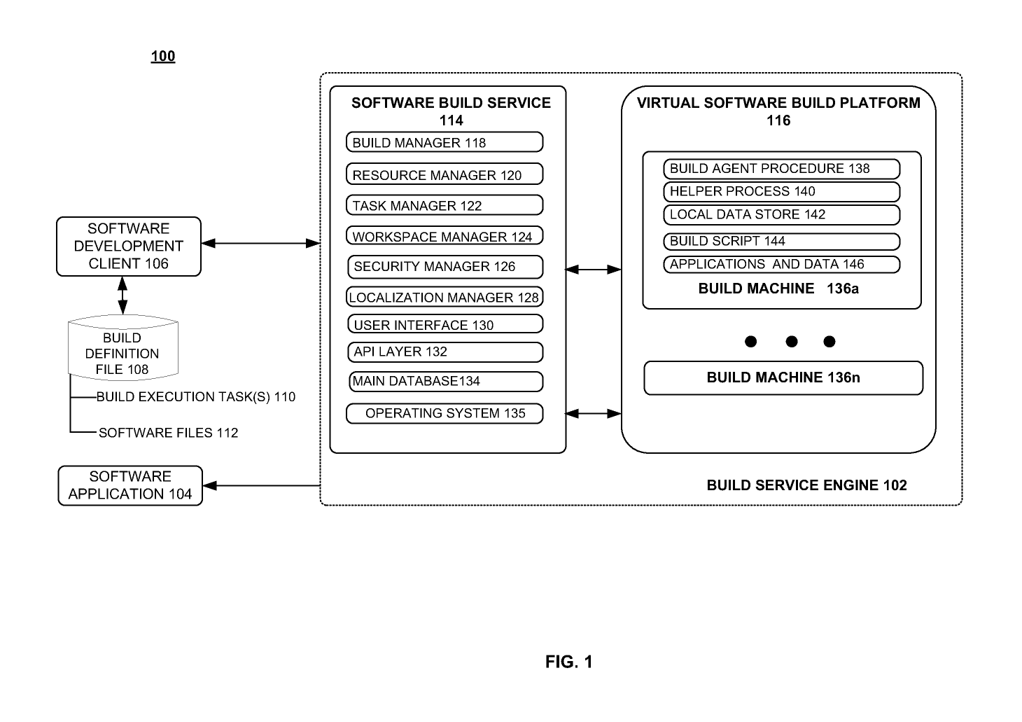

FIG. 1 illustrates a block diagram of an exemplary system for an uninterrupted upgrade of a build service engine. The system 100 may include a build service engine 102, a software application 104, at least one software development client 106, and a build definition file 108. The build service engine 102 is used to facilitate execution of several build execution tasks 110 in an automated manner for building a software application 104. The software application 104 is produced from the build service engine 102 and can be any type of software that can be deployed on a computing device, such as, an installation package, an operating system upgrade, a mobile phone application, and so forth.

The build service engine 102 may receive a subscription request from a software development client 106 and processes the subscription request to allow the software development client 106 to subscribe to the build services offered by the build service engine 102. The software development client 106 sends a build definition file 108 to the build service engine 102 providing information pertaining to a build job for producing the software application 104. In an embodiment, the build definition file 108 may specifically include build execution tasks 110 explicitly defining the tasks needed to create the software application 104. A build execution task 110 typically refers to a discrete portion of a build job. In an embodiment, each build execution task 110 may comprise a series of operations to produce a target file or set of target files such as reading from a file, writing to a file, renaming a file, compiling a source file, linking an object file, and so forth.

In an embodiment, the build definition file 108 may also include a plurality of software files 112 that are provided or described as part of the build job. The software files 112 can include source code, executables, dynamic link libraries, files, data structures, data bases, registry configurations, objects, etc. Alternatively, the build definition file 108 may provide a listing and/or location of the software files 112 that are needed for the build job.

The build service engine 102 may comprise a software build service 114 and a virtual software build platform 116. In some embodiments, the components of the build service engine 102 may be performed on multiple machines in multiple configurations. Although the build service engine 102 as shown in FIG. 1 has a limited number of elements in a certain configuration, it should be appreciated that the build service engine 102 may include more or less elements in alternate configurations.

The build service engine 102 utilizes the content provided in the build definition file 108 or defined within the build definition file 108 to determine a schedule for assigning the build execution tasks 110 to generate the software application 104. The software build service 114 controls the overall operation of the build job. The virtual software build platform 116 contains the hardware and software resources needed to perform the build execution tasks 110.

The software build service 114 may utilize a build manager 118, a resource manager 120, a task manager 122, a workspace manager 124, a security manager 126, a localization manager 128, a user interface 130, an API layer 132, a main database 134 and an operating system 135. It should be appreciated that the software build service 114 may include more or less elements in alternate arrangements as desired for a given implementation. Additionally, in some embodiments, each of these components can be distributed across multiple machines and/or machine configurations.

The build manager 118 generally manages the build process. Upon receipt of a build definition file 108, the build manager 118 creates a virtual software build platform 116 that builds the software application 104. In addition, the build manager 118 may receive control directives from a system administrator to perform system upgrades to one or more components of the build service engine 102.

The resource manager 120 generally manages the allocation of resources to build the virtual software build platform 116 for a particular build job. The resources can be build machines 136 having no relationship to a build execution task 110 by default. In response to a control directive from the build manager 118, the resource manager 120 may select and assign multiple build machines 136 to the virtual software build platform 116 to build the software application 104 based on the requirements indicated in the build definition file 108. For example, some build machines 136 may be equipped with software installed for a particular set of build execution tasks 110. The software may include different types of system programs, application programs, etc. In addition, some build machines 136 may have hardware already installed for a particular set of build execution tasks, including hardware for improving computing capabilities (e.g., multiple processors and/or processing cores, special-purpose co-processors, and so on), hardware for improving communications capabilities, hardware for enhancing memory resources, input/output devices for improving computing and/or communications capabilities, and other configurable hardware features.

A task manager 122 is generally used to assign and schedule build execution tasks for execution by one or more build machines 136. The task manager 122 may use a task scheduling algorithm to assign and schedule the build execution tasks for sequential builds or parallel builds. For example, multiple build execution tasks 110 can be performed in parallel on separate build machines, while other build execution tasks 110 can be performed sequentially on one build machine 136. The assignment and scheduling of the build execution 110 tasks is dependent on the nature of the build job and the availability of the resources required.

A workspace manager 124 uses dynamic workspace management techniques to enable any available build machine to execute incoming build execution tasks. The workspace manager 124 defines locations for a build machine to access information at various external sources. A security manager 126 manages security information for each of the software development clients 106 in order to ensure that a first software development client cannot access secure information from a second software development client and vice-versa. The security manager 126 may be arranged to manage security credentials for each of the software development clients 106 and/or the virtual software build platforms 116 to provide a secure execution environment for each of the virtual software build platform 116. A localization manager 128 manages local resources that are needed for a particular geographic region, including language conversions, function conversions, networking conversions, and so forth.

A user interface 130 includes a display to provide feedback and output data to a user regarding various stages of a build job or upgrade to the build service engine 102. The display can include various graphical elements such as display objects (e.g., icons, buttons, sliders, input boxes, selection options, menus, tabs, etc.), text, data, colors, and sounds to facilitate service deployment and upgrade status. The user interface 130 may be used to obtain input for adjusting and configuring the services of the build service engine 102.

In some embodiments, the user interface 130 may include a system console that is managed by a system administrator to monitor the build service engine 102. The system console may include a keyboard for textual input and a screen or display to display system administration messages. The system administration messages may be used to monitor the execution and performance of the various processes running in the build service engine 102. In addition, the system console may be used by the system administrator to perform system maintenance on the build service engine 102, including scheduling and monitoring software upgrades to the build service engine 102.

The API layer 132 is a programmable interface to the build service engine 102. The API layer 132 may be used to receive a build request from a software development client 106. In addition, the API layer 132 may be used to program customized access to the build service engine 102. Additionally or alternatively, the API layer 132 may provide access to features provided by the user interface 130.

The operating system 135 manages and coordinates the activities of the various components and resources of the build service engine 102. The operating system 135 relies on a main database 134 that stores information used by the operating system 135 to configure and operate the build service engine 102 for multiple users, applications, and machines. The main database 134 may contain, for example, information on each process that is executing in any machine of the build service engine 102, the configuration settings of each build machine 136, configuration settings of each user associated with a machine within the build service engine 102, performance data, and other information needed by the operating system 135.

In an embodiment, the main database 134 is a central repository for configuration data. In some embodiments, the main database 134 may be a registry configured as a hierarchical folder-like structure of registry hives. An entry in a registry hive may be associated with a name and a value. A component of the build service engine 102 may be any software, hardware component, thread, or process executing within the build service engine 102. As a component is initiated, the component retrieves a registry entry with a value and the value is modified during the course of its execution. The value is used to describe an attribute of its corresponding component.

It should be noted that although the term “registry” is commonly used in the context of a Windows®-based operating system, the technology disclosed herein is not constrained to any particular operating system or configuration database construct. Other techniques that provide a similar functionality can be employed as well, such as, without limitation, the configuration files used in Linux or Unix-based operating system, and the like.

The virtual software build platform 116 executes the build execution tasks set forth in the build definition file 108. The virtual software build platform 116 is customized by the software build service 114 to utilize one or more build machines 136 to generate the software application. The build machines 136 may include various generic and customized build machines implemented with communication interfaces for communicating with the software build service 114. A build machine 136 is an electronic device used for a build job, such as a computing device implemented as different types of servers. For example, a build machine may comprise a server having build tools, such as compliers, linkers, software libraries, device drivers, etc. The servers can be a general purpose computing device or a customized computing device, etc. multi-processor system, single processor systems, customized hardware devices. It may be appreciated that the build machine 136 may comprise more or less components consistent with the described embodiments.

Each build machine 136 may contain several components that are used to execute a build execution task 110. A build machine 136 may contain a build agent procedure 138, a helper process 140, a local data store 142, a build script 144, and various applications and data 146. The build agent procedure 138 is an application that runs on the build machine 136 under the direction of the software build service 114. The build agent procedure 138 receives directives from the software build service 114 and initiates a series of operations to perform the tasks of a build execution task 110. The helper process 140 is an independent process that is spawned from the build agent procedure 138 to monitor the execution of a build script. The local data store 142 may contain configuration data of the users, applications, and processes executing in a build machine 136. A build script 144 is a file containing commands that when initiated perform the processing indicated by the build execution task 110. For example, a build script can invoke a compilation of several source files to generate an object file that is then used by a linker to link certain library files with the object file. In addition, the build machine 136 may contain numerous other application software and data 146 needed to perform a build execution task, such as, compilers, linkers, test code, test data, data structures, code libraries, and the like.

Although the system 100 shown in FIG. 1 has a limited number of elements in a certain configuration, it should be appreciated that the system 100 can include more or less elements in alternate configurations. For example, the software build service 114 can be configured as a plurality of cooperative computing components, such as a configuration of servers or clients operating over a network. The services provided by each of the components of the software build service 114 can be distributed to multiple servers and clients communicatively coupled by several networks. The build definition file 108 can be configured as multiple build definition files, nested build definition files and/or related files that describe various configurations of services. In addition, the deployment of the services can occur within any type of distributed computing environment. For example, the servers can be arranged as plurality of client machines, a combination of server and client machines, wherein certain clients and server have various portion of the service distributed to it. Furthermore, the build definition file 108 can be combined, transported, and/or stored on any type of computer medium, such as, without limitation, a database, CD-ROM, floppy disk drive, DVD, and the like.

In various embodiments, the system 100 described herein may comprise a computer-implemented system having multiple components, programs, procedures, modules. As used herein these terms are intended to refer to a computer-related entity, comprising either hardware, a combination of hardware and software, or software. For example, a component may be implemented as a process running on a processor, a hard disk drive, multiple storage drives (of optical and/or magnetic storage medium), an object, an executable, a thread of execution, a program, and/or a computer. By way of illustration, both an application running on a server and the server may be a component. One or more components may reside within a process and/or thread of execution, and a component may be localized on one computer and/or distributed between two or more computers as desired for a given implementation. The embodiments are not limited in this manner.

The various components of system 100 may be communicatively coupled via various types of communications medium as indicated by various lines or arrows. The components may coordinate operations between each other. The coordination may involve the uni-directional or bi-directional exchange of information. For instance, the components may communicate information in the form of signals communicated over the communications medium. The information may be implemented as signals allocated to various signal lines. In such allocations, each message is a signal. Further embodiments, however, may alternatively employ data messages. Such data messages may be sent various connections. Exemplary connections include parallel interfaces, serial interfaces, and bus interfaces.

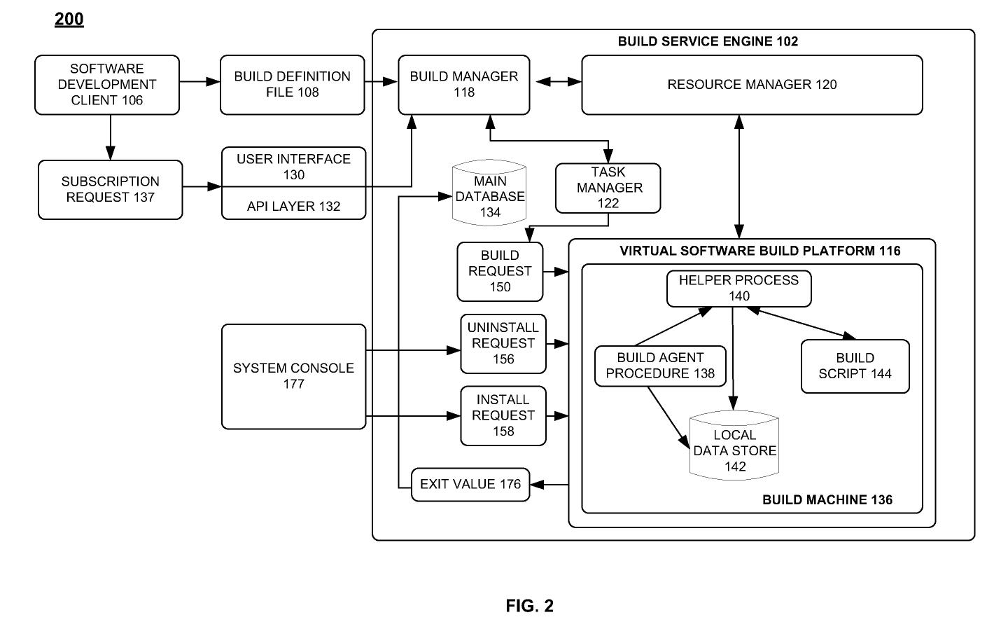

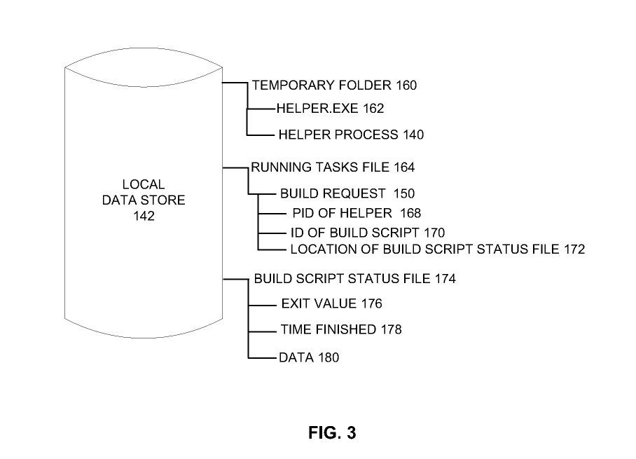

FIG. 2 illustrates an operating environment 200. FIG. 3 illustrates an exemplary local data store showing data structures used in the operating environment 200. The operating environment 200 provides an example of the software build service 114 creating a virtual software build platform 116, utilizing the virtual software build platform 116 to execute a build script, and upgrading a build agent procedure 138 during execution of a build script. Although the operating environment 200 as shown in FIG. 2 has a limited number of elements in a certain arrangement, it is understood that the operating environment 200 may include more or less elements in alternate arrangements as desired for a given implementation. The local data store shown in FIG. 3 has a limited number of elements in a certain arrangement and it should be understood that the local data store may include more or less elements in alternate arrangements as desired for a given implementation.

As shown in FIG. 2, the operating environment 200 illustrates the software development client 106 sending a subscription request 137 to the build service engine 102 via an API layer 132 and/or user interface 130. The build manager 118 processes the subscription request 138 to allow the software development client 106 to subscribe to the build services offered by the build service engine 102. Once subscribed to the build service engine 102, the software development client 106 may send a build definition file 108. In one embodiment, for example, the software production team is responsible for providing certain information and build definitions to the build service engine 102. For instance, the software production team is responsible for requesting, scheduling, monitoring, and fixing the software builds via the build service engine 102.

The build definition file 108 may comprise a structured input file or build script having formal definitions for automatically building executable programs and libraries from source code. The software application 104 may have literally tens of thousands of source files having complex interdependencies. The build definition file 108 may specify how to compile and link a target executable program from each of its dependencies. In an embodiment, the build definition file 108 may specifically include a list of build execution tasks and build definitions. A software production team subscribing to the build service engine 102 and utilizing a software development client 106 may precisely control a build process by explicitly defining the build execution tasks needed to create the software application 104.

The build manager 118 generally manages the build process and uses the build definition file 108 to create a virtual software build platform 116. For instance, the build manager 118 may send a control directive to the resource manager 120 to assign build resources to the virtual software build platform 116. In response to the control directive from the build manager 118, the resource manager 120 may select and assign multiple build machines 136 to the virtual software build platform 116. The resource manager 120 may select a specific build machine 136 based on the build execution tasks listed in the build definition file 108 and the hardware and software features installed in the specific build machine 136.

Once the virtual software build platform 116 has been created, the build manager 118 may send a control directive to the task manager 122 initiating assignment and scheduling of the build execution tasks. The task manager 122 may generally assign and schedule the build execution tasks for execution by each of the build machines 136. The task manager 122 may send one or more build requests 150 containing one or more build execution tasks to a build machine 136. The task manager 122 places a process identifier (PID) associated with each build request in the main database. The entry of the PID in the main database may be used by any of the services of the software build service or by a system administrator to monitor the status of a build request. The build agent procedure 138 in a build machine 136 receives the build request and prepares to execute the build execution tasks in the build request 150.

Upon receipt of the build request, the build agent procedure 138 is initiated. The build agent procedure 138 spawns off an independent process, herein referred to as the helper process 140. The build agent procedure 138 creates a temporary folder 160 for the helper process and a helper command file 162 to execute the helper process 140. As shown in FIG. 3, the temporary folder 160 may contain a helper command file, helper.exe, which when executed may invoke the helper process 140. The helper process 140 is program code that originates from the build agent procedure 138 but which is copied into the temporary folder as an independently-executed program. The build agent procedure 138 may also include other data in the temporary folder 160 for the helper process.

Next, the build agent procedure 138 creates an entry into a running tasks file 164 for the build request 150 and a build script status file 174 for the helper process 140 created for the build request 150. The running tasks file 164 may contain an entry for each build request 150 executing in the build machine. The build agent procedure 138 may enter in the running tasks file 164, a process id (PID) 152 of the helper process 140, an identifier associated with the build script 170, and the location of the build script status file 172 associated with the build script 144. The PID 152 is used to identify and track the helper process 140 that is associated with executing the build script and the identifier associated with the build script 170 is used to identify and track the execution of the build script 144.

The helper process 140 activates a build script 144 containing commands to execute operations in accordance with the build execution task contained in a build request 150. The helper process 140 monitors the execution of the build script 144 until the build script 144 completes. Upon completion of the build script 144, the helper process 140 updates the build script status file with an exit value 176 from the build script, the time finished 178 (i.e., the time that the build script finished processing), and other data as needed 180. The exit value 176 indicates completion of the build script 144. In some cases, the build script 144 may process successfully, without any errors or failures, and the exit value 176 will indicate successful completion. In other cases, the build script 144 may encounter errors or failures and the exit value 176 will reflect the type of error and/or failure. In addition, the helper process 140 ceases processing and the helper command file 162 deletes the temporary folder 160 and the contents therein, including the helper process 140.

The build agent procedure 138 monitors the build script status file 172 for completion of the helper process 140. When the exit value 176 of the build script 144 is stored in the local data store 142, the build agent procedure 138 transmits the exit value 176 to the main database 134. The main database 134 is updated so that the software build service 114 is aware that the build request 150 has completed. The entry for the build script 144 in the running tasks file 164 and the build script status file 174 is then deleted by the build agent procedure 138.

System maintenance is performed on most computing systems. System maintenance may be needed due to the installation of a new hardware device, to repair existing hardware, to install upgrades to various software files, to facilitate an emergency repair, and the like. A build service engine 102 can provide services to numerous software development clients 106 having time sensitive requirements, computationally intensive build jobs, and build jobs that take several hours to complete. In some situations, especially when a build job requires hundreds of build execution tasks, it may not be feasible or practical to wait for all the build execution tasks 110 to complete prior to performing an upgrade to any one component of the build service engine 102.

For example, an upgrade to the build agent procedure 138 would be difficult since a function of the build agent procedure 138 is to monitor the execution of the build scripts 144. In order for the build agent procedure 138 to be upgraded, all build scripts 144 running on a build machine 136 would have to finish processing prior to the installation of an upgraded version of the build agent procedure 138. At times, it may not be practical or feasible to wait for a build script 144 to complete especially if the build script 144 executes for several hours. Interrupting a build script 144 in midstream may result in build errors or failures when the build job resumes. Accordingly, a mechanism that facilitates upgrades to the build agent procedure 138 without interruptions to an in-progress build job is beneficial.

In some situations, the system maintenance may involve upgrading a large portion of the build service engine 102 while the build service engine 102 is executing in-progress build jobs. For example, a change in the communications protocol between the software build service 114 and the build agent procedure 138 may necessitate upgrading the software build service 114 and each of the build agent procedures 138 in the build machines 136. Additionally, the database schema of the main database 134 may change thereby necessitating an upgrade to all the components of the build service engine 102 that utilize the main database 134. In such situations, the components of the build service engine 102 are uninstalled and installed in a particular manner that ensures system integrity and that the in-progress progress build jobs are not interrupted. Otherwise, the build service engine 102 may have to accommodate multiple versions of the main database and/or software build service 114 which is more complex and may not be feasible or practical.

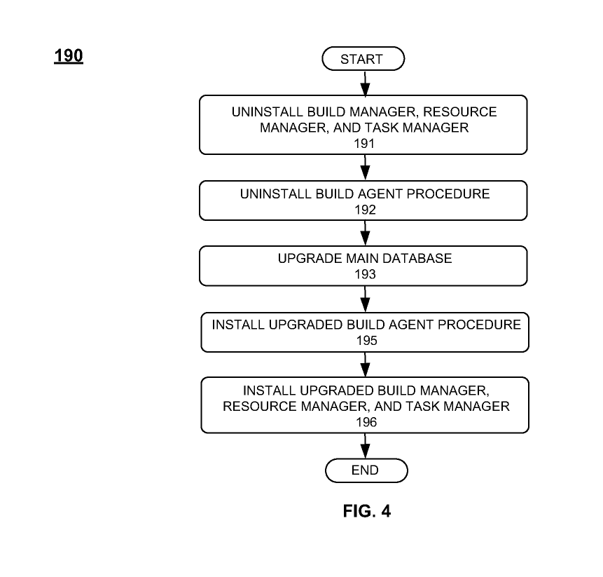

Referring to FIG. 4, there is shown an exemplary flow chart illustrating a process 190 to upgrade the build service engine. In several embodiments, a system administrator may utilize a system console to initiate actions to uninstall the build manager 118, the resource manager 120, and the task manager 122 of the software build service 114. Since the build manager 118, the resource manager 120, and the task manager 122 are involved in scheduling build execution tasks associated with building a software application, they are uninstalled first in order to temporarily suspend the scheduling of additional build execution tasks. The system administrator uninstalls the build manager 118, the resource manager 120, and the task manager 122 by terminating the processing or execution of these components. An uninstaller program may then be used to delete or erase the programs and data associated with the uninstalled component (block 191).

Next, the build agent procedure 138 in each build machine 136 may be uninstalled (block 192). The system administrator may transmit a request, through a system console, to each of the build machines 136 to uninstall their build agent procedure 138. Upon completion of uninstalling all the build agent procedures 138, the main database 134 is upgraded (block 193). Since the main database 134 is the central repository for all configurations, users, and processes in the build service engine 102, it is upgraded after all the components interacting with it have terminated processing and have been uninstalled (block 193).

The system administrator may then transmit a request, through the system console, to each of the build machines 136 to install an upgraded build agent procedure 138 (block 195). Upon completion of the installation of all the upgraded build agent procedures 138, upgraded versions of the build manager 118, the resource manager 120, and the task manager 122 are then installed (block 196).

In one or more embodiments, the installation may install an upgraded component or reinstall the original component. The process of uninstalling and installing all the components regardless of whether the installed component is an upgrade or not is done so that system errors, resulting from the system upgrade, are easily detected and corrected. Additionally, the process is simpler making it easy to implement and monitor.

Although the process 190 shown in FIG. 4 has a limited number of elements in a certain configuration, it should be appreciated that the system 190 can include more or less elements in alternate configurations. In addition, the system administrator can uninstall and/or install any of the components of the build service engine 102 in any order, such as in parallel and/or in series with uninstalling and/or installing other components. Attention now turns to a discussion of upgrading the build agent procedure without interrupting any in-progress build jobs. Referring back to FIGS. 2 and 3, in some embodiments, a system administrator may initiate through a system console 177 an uninstall request 156 to uninstall the build agent procedure 138 existing in one or more build machines 136. The uninstall request 156 may be made to all of the build machines simultaneously, one at a time, or in any order desired by the system administrator. The system administrator may wait for all build agent procedures in the build service engine 102 to be uninstalled before proceeding to make an install request 158 to each of the build machines 136 to install an upgraded build agent procedure. The install request 158 can be made to all of the build machines 136 simultaneously, serially, or in any order desired by the system administrator.

Once the upgraded build agent procedure 138 is installed, the build agent procedure 138 is then activated. The build agent procedure 138 reads the local data store 142 for any build scripts 144 that may have completed processing during the installation of the upgraded build agent procedure. In particular, the build agent procedure 138 reads each entry in the running tasks file for the location of the build script status file 174 associated with each running task. The presence of an exit value 176 in the associated build script status file 174 will be indicative of the build script having finished during the installation of the upgrade. In this case, the build agent procedure 138 may transmit the exit value 176 to the main database 134 and delete entries for the build script 144 in the running tasks file 164 and in the build script status file 174.

Operations for the embodiments may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

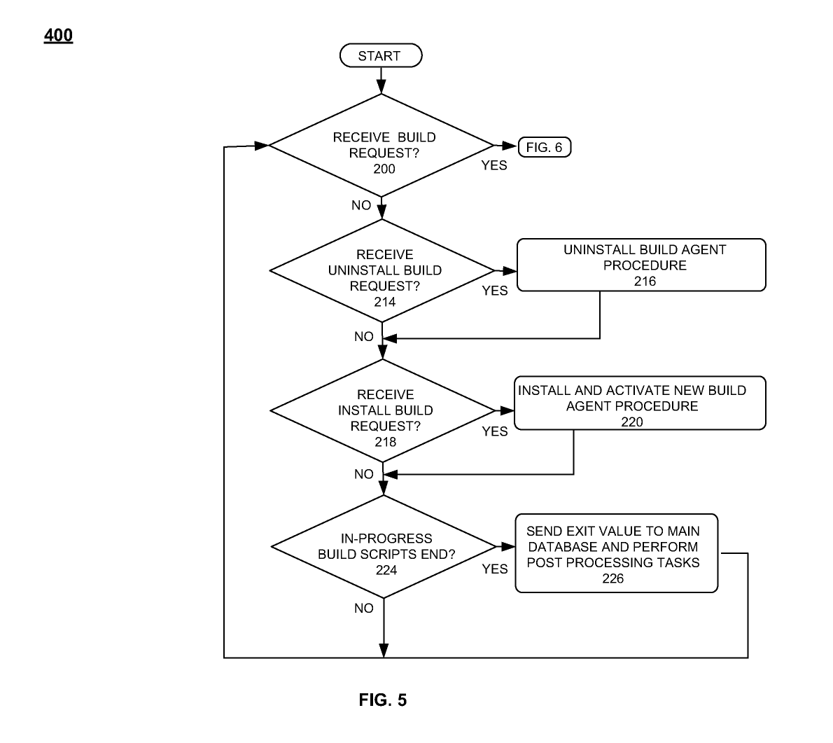

FIG. 5 illustrates a flow chart of an exemplary method of upgrading the build agent procedure. It should be noted that the method 400 may be representative of some or all of the operations executed by one or more embodiments described herein and that the method can include more or less operations than that which is described in FIG. 5. In an embodiment, the method may illustrate operations for the build service engine 102.

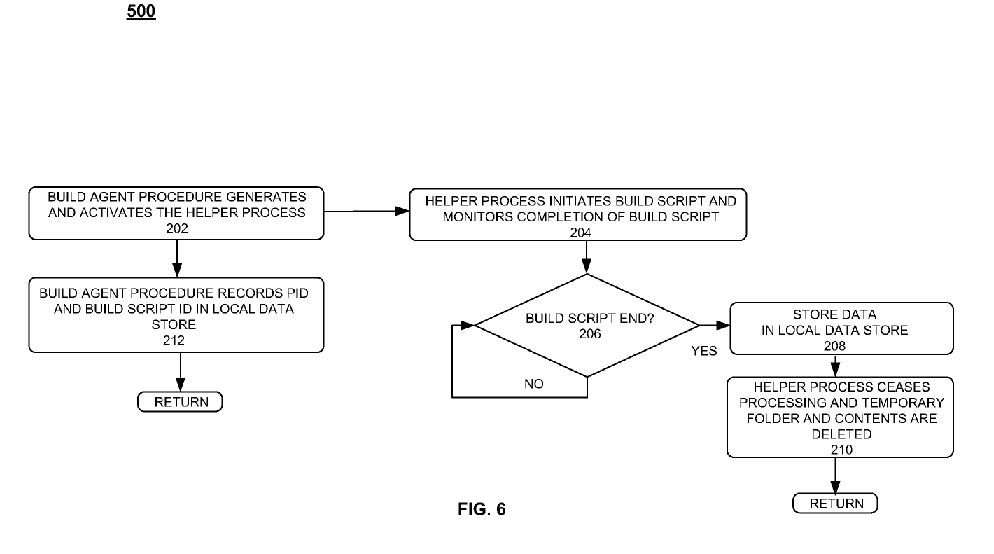

Referring to FIG. 5, a build machine 136 may receive a build request 150 that includes one or more build execution tasks (block 200—Yes). Referring to FIG. 6, in response to the build request 150, the build machine 136 invokes the build agent procedure 138 to generate and activate a helper process 140 (block 202). The build agent procedure 138 creates a temporary folder 160 in which a copy of the helper process 140 and a helper command file 162 is stored. The build agent procedure 138 may then invoke the helper command file 162 to execute the helper process 140. Once activated, the helper process 140 may initiate execution of the build script 144 (block 204) and monitor the execution of the build script 144 (block 206—No) until the build script 144 completes processing (block 206—Yes). Upon completion of the build script 144 (block 206—Yes), the helper process 140 may store data in the local data store pertaining to the completion of the build script (block 208). The helper process 140 may update the build script status file 174 with the exit value of the build script 144, the time finished 178 (i.e., the time that the build script finished) and other related bookkeeping data (block 208). In addition, the helper process 140 ceases processing and the helper command file 162 deletes the temporary folder 160 and the contents contained therein (block 210).

Concurrently as the helper process 140 is executing, the build agent procedure 138 records an entry in the running tasks file 164 for the build request 150 which may include a PID associated with the helper process 168, an identifier for the associated build script 170, and a location of an associated build script status file 172 (block 212).

Referring back to FIG. 5, if the build machine receives an uninstall request 156 to uninstall the build agent procedure (block 214—Yes), the build machine 136 prepares to uninstall the build agent procedure 138 (block 216). In uninstalling the build agent procedure 138, all the data, files and programs associated with the uninstalled program are deleted. Otherwise (block 214—No), if the build machine 136 receives an install request 158 (block 218—Yes), the build machine 136 installs the new or updated build agent procedure which is then activated (block 220). In installing a new build agent procedure, the files, data, programs, etc. associated with the new build agent procedure are stored in the build machine in a predefined location known to the operating system and then activated. The build agent procedure 138 then checks the running tasks file 164 to determine if any in-progress build scripts have completed processing (block 224). If a build script has completed processing (block 224—Yes), the build agent procedure 138 sends the exit value associated with the build script to the main database and performs post processing tasks that signify completion of the build script (block 226). In addition, the build agent procedure 138 deletes the entry associated with the build script in the running tasks file 164 and in the build script status file 174 (block 226). In the event there are no in-progress build scripts or there are not any in-progress build scripts that have completed processing (block 224—No), the processing continues polling for another event to occur.

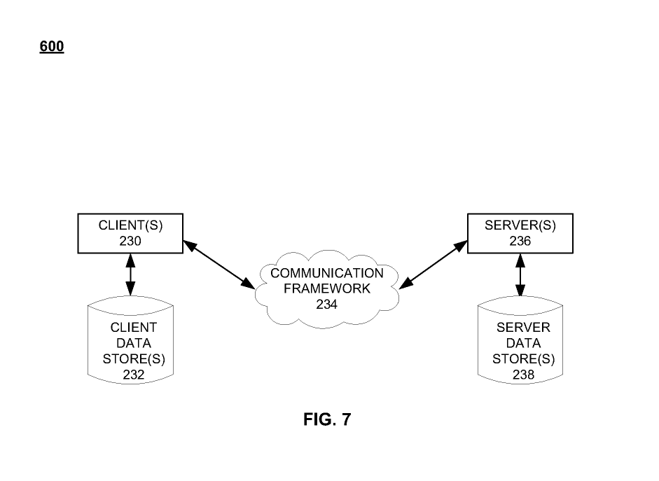

Referring now to FIG. 7, there is shown a schematic block diagram of an exemplary computing environment 600. The environment 600 may include one or more client(s) 230 in communication through a communications framework 234 with one or more server(s) 236. The clients 230 may implement the client systems, such as the build machines 136 and the servers 194 may implement the software build service 114 and alternatively, one or more of the components 118, 120, 122, 124, 126, 128, 130, 134 of the software build service 114.

A client 230 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A client 230 may also be embodied as a software module having instructions that execute in a single execution path, multiple concurrent execution paths (e.g., thread, process, etc.), or in any other manner.

A server 236 may be embodied as a hardware device, a software module, or as a combination thereof. Examples of such hardware devices may include, but are not limited to, a computer (e.g., server, personal computer, laptop, etc.), a cell phone, a personal digital assistant, or any type of computing device, and the like. A server 236 may also be embodied as a software module having instructions that execute in a single execution path, multiple concurrent execution paths (e.g., thread, process, etc.), or in any other manner.

The communications framework 234 facilitates communications between the client 230 and the server 236. The communications framework 234 may embody any type of communications medium, such as wired or wireless networks, utilizing any communication protocol. Each client(s) 230 may be coupled to one or more client data store(s) 232 that store information local to the client 230. Each server(s) 236 may be coupled to one or more server data store(s) 238 that store information local to the server 236.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise an article of manufacture. An article of manufacture may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software components, such as programs, procedures, module, applications, code segments, program stacks, middleware, firmware, methods, routines, and so on. In an embodiment, for example, an article of manufacture may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

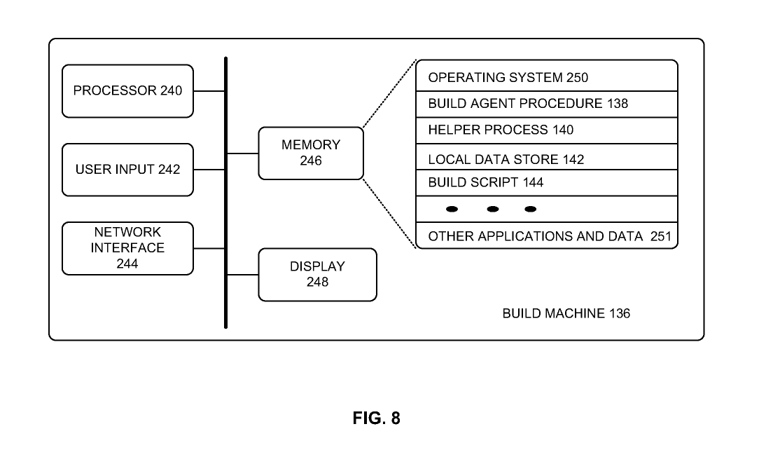

FIG. 8 illustrates a block diagram of an exemplary build machine 136. A build machine 136 may have a processor 240, a user input 242, a network interface 244 for facilitating network communications, a memory 246, and a display 248. The memory 246 may be any computer-readable storage media that may store executable procedures, applications, and data. It may be any type of memory device (e.g., random access memory, read-only memory, etc.), magnetic storage, volatile storage, non-volatile storage, optical storage, DVD, CD, and the like. The memory 246 may also include one or more external storage devices or remotely located storage devices. The memory may 246 contain instructions and data as follows:
an operating system 250;
a build agent procedure 138;
a helper process 140;
a local data store 142;
a build script 144; and
various other applications and data 251.

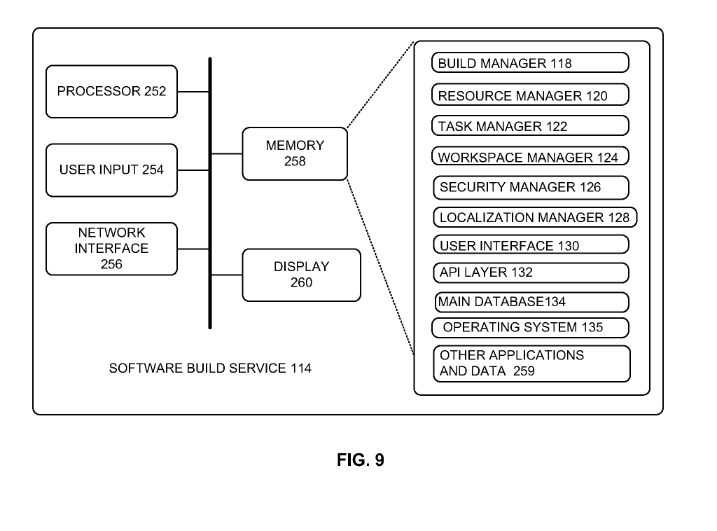

FIG. 9 illustrates a block diagram of an exemplary software build service 114. The software build service 114 may have a processor 252, a user input 254, a network interface 256 for facilitating network communications, a memory 258, and a display 260. The memory 258 may be any computer-readable storage media that can store executable procedures, applications, and data. It may be any type of memory device (e.g., random access memory, read-only memory, etc.), magnetic storage, volatile storage, non-volatile storage, optical storage, DVD, CD, and the like. The memory 258 may also include one or more external storage devices or remotely located storage devices. The memory 258 may contain instructions and data such as one or more of the following:
a build manager 118;
a resource manager 120;
a task manager 122;
a workspace manager 124;
a security manager 126;
a localization manager 128;
a user interface 130;
an API layer 132;
a main database 134;
an operating system 135; and
other applications and data 259.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method, comprising:
receiving, at a build agent procedure, a build request to execute at least one build execution task, the build execution task used in formulating a software application;
generating, by the build agent procedure, a helper process associated with the build request; and
invoking the helper process to execute the build execution task.

2. The method of claim 1, comprising:
terminating processing of the build agent procedure during execution of the build execution task.

3. The method of claim 2, comprising:
uninstalling the build agent procedure during execution of the build execution task.

4. The method of claim 3, comprising:
replacing the build agent procedure with an upgraded build agent procedure during execution of the build execution task.

5. The method of claim 4, comprising:
storing first data pertaining to initiation of the helper process and the build request; and
storing second data pertaining to completion of build request.

6. The method of claim 5, comprising:
determining, by the upgraded build agent procedure, completion of the build request from the stored first and second data.

7. The method of claim 1, comprising:
storing, by the build agent procedure, data pertaining to the helper process and the build request at a first location.

8. The method of claim 7, comprising:
storing, by the helper process, data pertaining to completion of the build execution task at a second location.

9. The method of claim 8, comprising:
determining, by the build agent procedure, completion of the build execution task from the data stored in the first and second locations.

10. An apparatus, comprising:
a processor; and
a memory unit coupled to the processor, the memory unit to store a build agent procedure that when executed by the processor receives at least one build request, the build request having at least one build execution task used to generate at least a portion of a software application, the build agent procedure when executed by the processor generates a helper process to execute the build execution task, the build agent procedure when executed by the processor monitors for completion of the helper process.

11. The apparatus of claim 10, comprising:
the build agent procedure, when executed by the processor, receives an uninstall request while a build execution task is executing, the build agent ceases processing while the build execution task is executing.

12. The apparatus of claim 10, comprising:
a first memory location for storing a helper process identifier and a build request identifier, the helper process identifier associated with a helper process, the build request identifier associated with a build request.

13. The apparatus of claim 12, comprising:
a second memory location for storing an exit value associated with completion of the build request.

14. The apparatus of claim 13, comprising;
the build agent procedure, when executed by the processor, utilizes the first and second memory locations to determine completion of a build request.

15. The apparatus of claim 13, comprising:
a network interface to transfer the exit value to an external database.

16. An article of manufacture comprising a storage medium containing instructions that when executed enable a system to:
create a helper process to execute a build script, the build script including at least one build execution task used in formulating a software application;
create a helper command file to execute the helper process; and
execute the helper command file.

17. The article of manufacture of claim 16, further comprising instructions that when executed enable a system to:
activate a build agent procedure to create the helper process in response to receipt of a build request, the build request having one or more build execution tasks.

18. The article of manufacture of claim 17, further comprising instructions that when executed enable a system to:
replace the build agent procedure with an upgraded build agent procedure during execution of the helper process.

19. The article of manufacture of claim 18, further comprising instructions that when executed enable a system to:
initiate the upgraded build agent procedure to monitor completion of the build script at a location identified by the build agent procedure.

20. The article of claim 19, further comprising instructions that when executed enable the system to:
notify a main database of completion of the build script.
